(19) United States
(12) Patent Application Publication
(10) Pub. No.: US 2026/0211092 A1
(43) Pub. Date: Jul. 23, 2026

(54) CONTROL DEVICE, OPTICAL SENSOR, CONTROL METHOD, AND STORAGE MEDIUM THEREOF

(71) Applicant: DENSO CORPORATION, Kariya-shi (JP)

(72) Inventors: Ryo YAMAMOTO, Kariya-city (JP); Keiko AKIYAMA, Kariya-city, (JP)

(21) Appl. No.: 19/569,877

(22) Filed: Mar. 17, 2026

Related U.S. Application Data
(63) Continuation of application No. PCT/JP2024/028048, filed on Aug. 6, 2024.

(30) Foreign Application Priority Data
Sep. 21, 2023 (JP) 2023-156249
Dec. 26, 2023 (JP) 2023-219876

(51) Int. Cl. G01S 7/497; G01S 17/08

(52) U.S. Cl. CPC G01S 7/497; G01S 17/08

(57) ABSTRACT

A control device includes a processor, which is configured to control an optical sensor. The optical sensor receives a reflection beam, which is generated when a projection beam projected toward a detection area is reflected by a target, and outputs detection data indicating a distance to the target. The processor is configured to: update a storage parameter, which is stored in a storage medium as a correction parameter, in response to a variation range of the correction parameter falling outside an allowable range by monitoring the variation range of the correction parameter; and correct the detection data with the correction amount corresponding to the temperature at which each detection of the distance is performed in accordance with the correction model provided according to a latest storage parameter.

### CROSS REFERENCE TO RELATED APPLICATION

The present application is a continuation application of International Patent Application No. PCT/JP2024/028048 filed on Aug. 6, 2024, which designated the U. S. and claims the benefit of priority from Japanese Patent Application No. 2023-156249 filed on Sep. 21, 2023, and Japanese Patent Application No. 2023-219876 filed on Dec. 26, 2023. The entire disclosures of all of the above applications are incorporated herein by reference.

### TECHNICAL FIELD

The present disclosure relates to a technology for controlling an optical sensor.

### BACKGROUND

Conventionally, an optical sensor is controlled to receive a reflection beam from a target when a projection beam projected to a detection area is reflected by the target, and detect a distance to the target based on the reflection beam. As a type of such a control technology, a measurement time equivalent to a detection distance is corrected using a delay time due to processing in a control unit as a correction amount.

### SUMMARY

According to an aspect of the present disclosure, a control device includes at least one of (i) a circuit and (ii) a processor with a memory storing computer program code executable by the processor. The at least one of the circuit and the processor is configured to control an optical sensor. The optical sensor is configured to receive a reflection beam, which is generated when a projection beam projected toward a detection area is reflected by a target, and output detection data indicating a distance to the target. The at least one of the circuit and the processor may be configured to update a storage parameter, which is stored in a storage medium as a correction parameter, in response to a variation range of the correction parameter falling outside an allowable range by monitoring the variation range of the correction parameter. The correction parameter defines a dependence level of a correction amount for the distance on a temperature in a correction model for correcting the detection data of the distance corresponding to the temperature. The at least one of the circuit and the processor may be configured to correct the detection data with the correction amount corresponding to the temperature at which each detection of the distance is performed in accordance with the correction model provided according to a latest storage parameter.

### BRIEF DESCRIPTION OF DRAWINGS

The present disclosure will become apparent from the following detailed description made with reference to the accompanying drawings. In the drawings:

FIG. 1 is a cross-sectional view showing an overall configuration of an optical sensor according to a first embodiment;

FIG. 2 is a block diagram showing a functional configuration of the optical sensor according to the first embodiment;

FIG. 3 is a schematic diagram showing a projection light source unit according to the first embodiment;

FIG. 4 is a schematic diagram showing a light receiving detection unit according to the first embodiment;

FIG. 5 is a flowchart showing a control flow according to the first embodiment;

FIG. 6 is a time chart for explaining the control flow according to the first embodiment;

FIG. 7 is a characteristic diagram for explaining the control flow according to the first embodiment;

FIG. 8 is a characteristic diagram for explaining the control flow according to the first embodiment;

FIG. 9 is a characteristic diagram for explaining the control flow according to the first embodiment;

FIG. 10 is a cross-sectional view showing a modification of FIG. 2;

FIG. 11 is a characteristic diagram for explaining the control flow according to the first embodiment;

FIG. 12 is a characteristic diagram for explaining a control flow according to a second embodiment;

FIG. 13 is a characteristic diagram for explaining a control flow according to a third embodiment; and

FIG. 14 is a characteristic diagram for explaining a control flow according to a fourth embodiment.

### DETAILED DESCRIPTION

In a known optical sensor, a delay time corresponding to a temperature extracted by another optical sensor in the same mobile object is extracted according to a map prepared in advance. However, an error occurring in the measurement time equivalent to the detection distance is caused not only by the delay time due to the processing executed by the control unit but also by, for example, aging deterioration of sensor elements constituting the optical sensor and an abnormality due thereto. Therefore, in the known optical sensor, even if a change occurs in the error with the passage of time, there is a concern that the detection accuracy of the distance may decrease since the distance corresponding to the measurement time is corrected according to the map which is always invariant.

According to a first aspect of the present disclosure, a control device includes at least one of (i) a circuit and (ii) a processor with a memory storing computer program code executable by the processor. The at least one of the circuit and the processor is configured to control an optical sensor. The optical sensor is configured to receive a reflection beam, which is generated when a projection beam projected toward a detection area is reflected by a target, and output detection data indicating a distance to the target. The at least one of the circuit and the processor is configured to update a storage parameter, which is stored in a storage medium as a correction parameter, in response to a variation range of the correction parameter falling outside an allowable range by monitoring the variation range of the correction parameter. The correction parameter defines a dependence level of a correction amount for the distance on a temperature in a correction model for correcting the detection data of the distance corresponding to the temperature. The at least one of the circuit and the processor is configured to correct the detection data with the correction amount corresponding to the temperature at which each detection of the distance is performed in accordance with the correction model provided according to a latest storage parameter.

According to a second aspect of the present disclosure, a control method is executed by a processor for controlling an optical sensor. The optical sensor is configured to receive a reflection beam, which is generated when a projection beam projected toward a detection area is reflected by a target, and output detection data indicating a distance to the target. The control method includes: updating a storage parameter, which is stored in a storage medium as a correction parameter, in response to a variation range of the correction parameter falling outside an allowable range by monitoring the variation range of the correction parameter, the correction parameter defining a dependence level of a correction amount for the distance on a temperature in a correction model for correcting the detection data of the distance corresponding to the temperature; and correcting the detection data with the correction amount corresponding to the temperature at which each detection of the distance is performed in accordance with the correction model provided according to a latest storage parameter.

According to a third aspect of the present disclosure, a control program for controlling an optical sensor is provided. The optical sensor is configured to receive a reflection beam, which is generated when a projection beam projected toward a detection area is reflected by a target, and output detection data indicating a distance to the target. The control program includes instructions for causing a processor of the optical sensor to execute: updating a storage parameter, which is stored in a storage medium as a correction parameter, in response to a variation range of the correction parameter falling outside an allowable range by monitoring the variation range of the correction parameter, the correction parameter defining a dependence level of a correction amount for the distance on a temperature in a correction model for correcting the detection data of the distance corresponding to the temperature; and correcting the detection data with the correction amount corresponding to the temperature at which each detection of the distance is performed in accordance with the correction model provided according to a latest storage parameter.

According to the first to third aspects, in the correction model for correcting the detection data of the distance depending on the temperature, the variation range of the correction parameter defining the dependence level of the temperature with respect to the correction amount of the distance is monitored. Therefore, when the variation range of the correction parameter falls outside the allowable range, the storage parameter stored in the storage medium as the correction parameter is updated. Therefore, by correcting the detection data using the correction amount corresponding to the temperature at each detection of the distance in accordance with the correction model provided according to the latest storage parameter, it becomes possible to output the detection data in which the detection accuracy of the distance is secured regardless of the passage of time.

According to a fourth aspect of the present disclosure, a control device includes at least one of (i) a circuit and (ii) a processor with a memory storing computer program code executable by the processor. The at least one of the circuit and the processor is configured to control an optical sensor. The optical sensor is configured to receive a reflection beam, which is generated when a projection beam projected toward a detection area is reflected by a target, and output detection data indicating a distance to the target. The at least one of the circuit and the processor is configured to monitor a failure index correlating with a variation range of a correction parameter. The correction parameter defines a dependence level of a correction amount for the distance on a temperature in a correction model for correcting the detection data of the distance corresponding to the temperature. The at least one of the circuit and the processor is configured to output failure notification information notifying a failure state of the optical sensor in which the failure index falls outside an allowable range.

According to a fifth aspect of the present disclosure, a control method is executed by a processor for controlling an optical sensor. The optical sensor is configured to receive a reflection beam, which is generated when a projection beam projected toward a detection area is reflected by a target, and output detection data indicating a distance to the target. The control method includes monitoring a failure index correlating with a variation range of a correction parameter, the correction parameter defining a dependence level of a correction amount for the distance on a temperature in a correction model for correcting the detection data of the distance corresponding to the temperature; and outputting failure notification information notifying a failure state of the optical sensor in which the failure index falls outside an allowable range.

According to a sixth aspect of the present disclosure, a control program for controlling an optical sensor is provided. The optical sensor is configured to receive a reflection beam, which is generated when a projection beam projected toward a detection area is reflected by a target, and output detection data indicating a distance to the target. The control program includes instructions for causing a processor of the optical sensor to execute: monitoring a failure index correlating with a variation range of a correction parameter, the correction parameter defining a dependence level of a correction amount for the distance on a temperature in a correction model for correcting the detection data of the distance corresponding to the temperature; and outputting failure notification information notifying a failure state of the optical sensor in which the failure index falls outside an allowable range.

According to the fourth to sixth aspects, in the correction model for correcting the detection data of the distance depending on the temperature, the failure index correlating with the variation range of the correction parameter defining the dependence level of the temperature with respect to the correction amount of the distance is monitored. Therefore, the failure notification information notifying the failure state is outputted with the state of the optical sensor in which the failure index falls outside the allowable range as the failure state. In this way, in the optical sensor, since the failure state can be accurately notified by the failure notification information, conversely, under a normal state without the notification, the detection data is corrected according to the temperature at each detection of the distance in accordance with the correction model, whereby it becomes possible to output the detection data in which the detection accuracy of the distance can be secured.

According to a seventh aspect of the present disclosure, a control device includes at least one of (i) a circuit and (ii) a processor with a memory storing computer program code executable by the processor. The at least one of the circuit and the processor is configured to control an optical sensor. The optical sensor is configured to receive a reflection beam, which is generated when a projection beam projected toward a detection area is reflected by a target, and output detection data indicating a distance to the target. The at least one of the circuit and the processor is configured to monitor a failure index correlating with a variation range of a correction parameter. The correction parameter defines a dependence level of a correction amount for the distance on a temperature in a correction model for correcting the detection data of the distance corresponding to the temperature. The at least one of the circuit and the processor is configured to adjust a control parameter for controlling the optical sensor to recover from a failure state of the optical sensor in which the failure index falls outside an allowable range.

According to an eighth aspect of the present disclosure, a control method is executed by a processor for controlling an optical sensor. The optical sensor is configured to receive a reflection beam, which is generated when a projection beam projected toward a detection area is reflected by a target, and output detection data indicating a distance to the target. The control method includes: monitoring a failure index correlating with a variation range of a correction parameter, the correction parameter defining a dependence level of a correction amount for the distance on a temperature in a correction model for correcting the detection data of the distance corresponding to the temperature; and adjusting a control parameter for controlling the optical sensor to recover from a failure state of the optical sensor in which the failure index falls outside an allowable range.

According to a ninth aspect of the present disclosure, a control program for controlling an optical sensor is provided. The optical sensor is configured to receive a reflection beam, which is generated when a projection beam projected toward a detection area is reflected by a target, and output detection data indicating a distance to the target. The control program includes instructions for causing a processor of the optical sensor to execute: monitoring a failure index correlating with a variation range of a correction parameter, the correction parameter defining a dependence level of a correction amount for the distance on a temperature in a correction model for correcting the detection data of the distance corresponding to the temperature; and adjusting a control parameter for controlling the optical sensor to recover from a failure state of the optical sensor in which the failure index falls outside an allowable range.

According to the seventh to ninth aspects, in the correction model for correcting the detection data of the distance depending on the temperature, the failure index correlating with the variation range of the correction parameter defining the dependence level of the temperature with respect to the correction amount of the distance is monitored. Therefore, with the state of the optical sensor in which the failure index falls outside the allowable range as the failure state, the control parameter for controlling the optical sensor is adjusted to the recover from the failure state. In this way, in the optical sensor, since recovery of the failure state can be attempted by the adjustment of the control parameter, under the recovery, the detection data is corrected according to the temperature at each detection of the distance in accordance with the correction model, whereby it becomes possible to output the detection data in which the detection accuracy of the distance can be secured.

According to a tenth aspect of the present disclosure, an optical sensor includes a control unit including the control device according to the first, fourth, or seventh aspect. The control unit is configured to generate the detection data, and outputs the detection data indicating a distance to a target. The detection data is generated by receiving the reflection beam from the target when a projection beam is projected toward a detection area and reflected by the target. The optical sensor further includes a projection unit configured to project the projection beam in accordance with control by the control unit, and a light receiving unit configured to receive the reflection beam in accordance with control by the control unit.

The optical sensor of the tenth aspect can provide operational effects based on the same principle as the control device of the first, fourth, or seventh aspect.

Hereinafter, multiple embodiments of the present disclosure will be described based on the drawings. Note that same reference symbols may be assigned to corresponding components in each embodiment to omit redundant description. In addition, when only a part of a configuration is described in each embodiment, the configuration of another embodiment described previously can be applied to other parts of the configuration. Furthermore, not only combinations of configurations explicitly stated in the description of each embodiment, but also configurations of multiple embodiments can be partially combined with each other even if not explicitly stated, provided that there is no particular hindrance to the combination.

### First Embodiment

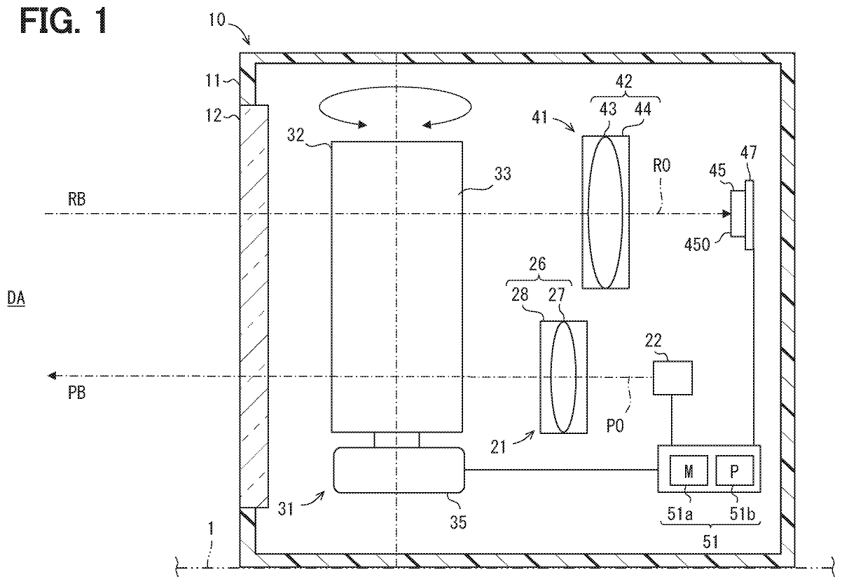

As shown in FIG. 1, an optical sensor 10 according to a first embodiment of the present disclosure is configured to be mountable on a mobile object 1. The optical sensor 10 may be implemented by a LIDAR (Light Detection and Ranging/Laser Imaging Detection and Ranging) for optically detecting an external environment of the mobile object 1. The mobile object 1 to which the optical sensor 10 is applied is, for example, an automobile or the like capable of performing at least one type of manual driving, autonomous driving, or remote driving. In the following description, unless otherwise noted, directions indicated by front, rear, up, down, left, and right are defined with reference to the mobile object 1 on a horizontal plane. In the following description, a horizontal direction means a parallel direction to the horizontal plane, and a vertical direction means a direction perpendicular to the horizontal plane, in the mobile object 1 located on the horizontal plane. In FIG. 1, a portion on a left side of a dash-dotted line along the vertical direction (a cover panel 12 side described later) actually illustrates a cross section perpendicular to a portion on a right side of the dash-dotted line (side of each unit 21, 41 described later).

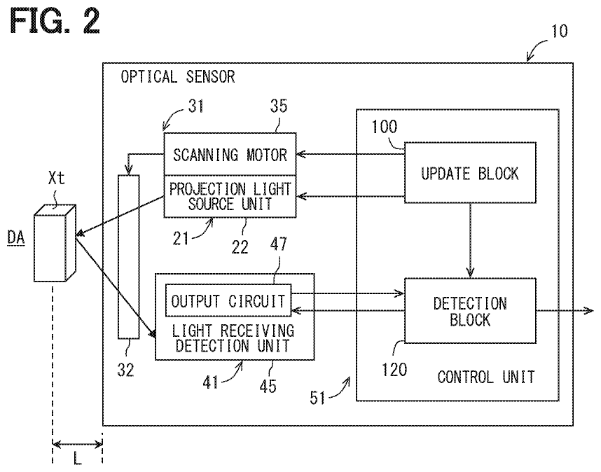

The optical sensor 10 is arranged in the mobile object 1 at, for example, a front portion, left and right lateral side portions, a rear portion, or an upper roof. As shown in FIG. 1 and FIG. 2, the optical sensor 10 projects a projection beam PB toward a detection area DA in the external environment. The detection area DA is defined corresponding to an arrangement location of the mobile object 1. The optical sensor 10 detects, as a reflection beam RB, return light of the projection beam PB after being reflected by a target Xt in the detection area DA of the external environment. Thus, light in a near-infrared region which is difficult for humans to visually recognize is selected for the projection beam PB, which also serves as the reflection beam RB.

The optical sensor 10 detects the target Xt existing in the detection area DA of the external environment by receiving the reflection beam RB reflected with respect to the projection beam PB. Detection of such an external environment target Xt includes, detection of a distance L from the optical sensor 10 to the target Xt, and may further include detection of a direction in which the target Xt exists or detection of reflection intensity of the reflection beam RB from the target Xt. The target Xt serving as a representative detection object relative to the optical sensor 10 applied to the mobile object 1 may be at least one type of moving object, for example, a pedestrian, a cyclist, an animal other than a human, or another vehicle. The target Xt serving as a representative detection object relative to the optical sensor 10 applied to the mobile object 1 may be at least one type of stationary object, for example, a guardrail, a road sign, a roadside structure, and a fallen object on the road.

As shown in FIG. 1, the optical sensor 10 includes a housing unit 11, a projection unit 21, a scanning unit 31, a light receiving unit 41, and a control unit 51. The light-shielding housing unit 11 has a box shape, and is made of, for example, metal, resin, or the like. The housing unit 11 accommodates the projection unit 21, the scanning unit 31, the light receiving unit 41, and the control unit 51 therein. An opening penetrating from inside to outside of the housing unit 11 is covered by a cover panel 12. The translucent cover panel 12 is made of, for example, resin, glass, or the like, and partitions the inside and outside of the housing unit 11.

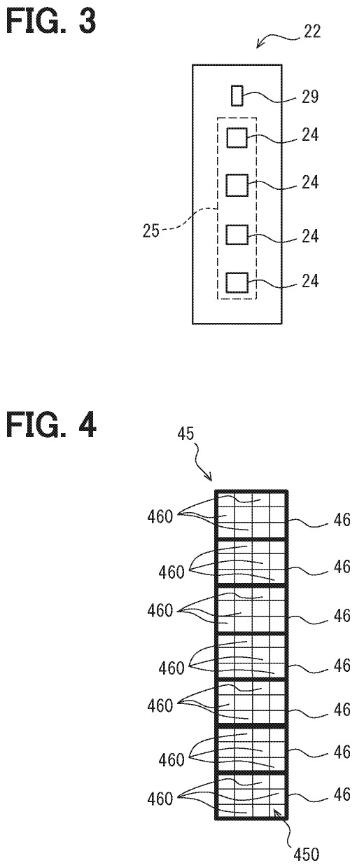

As shown in FIG. 1 and FIG. 2, the projection unit 21 has a projection light source unit 22 and a projection lens unit 26. As shown in FIG. 3, the projection light source unit 22 is constructed by mounting multiple light source elements 24 in an array on a substrate. Each light source element 24 is a laser diode, and the multiple light source elements are arranged in a single row (example in FIG. 3) or multiple rows (not shown) along the vertical direction. Each light source element 24 generates laser light serving as a part of the projection beam PB in a pulse shape according to a control signal from the control unit 51. Each light source element 24 may be an edge emitter laser or a vertical cavity surface emitting laser (VCSEL).

The projection light source unit 22 provides a light source window 25 fictitiously defined with a rectangular contour having longitudinal sides along the vertical direction and transverse sides along the horizontal direction on one surface of the substrate. The light source window 25 is configured as an aggregate of laser oscillation apertures in respective light source elements 24. The laser light projected from the laser oscillation aperture of each light source element 24 is projected from the light source window 25 as the projection beam PB fictitiously regarded as a line beam that has a longitudinal shape along the vertical direction at least in the detection area DA of the external environment.

As shown in FIG. 1, the projection lens unit 26 has a structure in which at least one projection lens 27 is held by a lens barrel 28. The translucent projection lens 27 has a shape corresponding to an optical action to be exerted, and is mainly made of base material, such as resin or glass. The projection lens 27 exerts at least one type of optical action among, for example, condensing, collimating, shaping, and the like on the projection beam PB emitted from the projection light source unit 22. The projection lens 27 is arranged in the light-shielding lens barrel 28, which is made of, for example, metal, resin, or the like. The projection lens unit 26 having such a configuration has a projection optical axis PO for guiding the projection beam PB toward the scanning unit 31 by being aligned with the projection light source unit 22.

As shown in FIG. 1 and FIG. 2, the scanning unit 31 has a scanning mirror 32 and a scanning motor 35. The scanning mirror 32 has a plate shape, and a reflective film is vapor-deposited on a reflection surface 33 which is one surface of a base material of the scanning mirror. The scanning mirror 32 is supported by the housing unit 11 so as to be rotationally drivable around a rotation center line arranged along the vertical direction. The scanning mirror 32 oscillates within a drive range limited by a mechanical or electrical stopper.

The scanning motor 35 is, for example, a voice coil motor, a brushed DC motor, a stepping motor, or the like. An output shaft of the scanning motor 35 is coupled to the scanning mirror 32 directly, or coupled to the scanning mirror 32 indirectly via a drive mechanism such as a speed reducer. The scanning motor 35 is supported by the housing unit 11 so as to be capable of rotationally driving the scanning mirror 32 together with the output shaft. The scanning motor 35 rotationally drives, that is, oscillates the scanning mirror 32 within the finite drive range according to a control signal from the control unit 51.

The scanning mirror 32 reflects the projection beam PB incident from the projection unit 21 by the reflection surface 33 and projects the light beam toward the detection area DA through the cover panel 12, thereby scanning the area DA corresponding to a rotation angle of the scanning motor 35. In the present embodiment, scanning of the detection area DA by the projection beam PB is substantially limited to scanning in the horizontal direction according to the rotational driving of the scanning mirror 32.

The scanning mirror 32 reflects, using the reflection surface 33, the reflection beam RB incident from the target Xt existing in the detection area DA through the cover panel 12 toward the light receiving unit 41, corresponding to the rotation angle of the scanning motor 35. At this time, speeds of the projection beam PB and the reflection beam RB are sufficiently high relative to a rotational movement speed of the scanning mirror 32. Accordingly, the reflection beam RB is generated by a reflection action on the scanning mirror 32 whose rotation angle with respect to the rotation angle of the projection beam PB can be fictitiously regarded as substantially the same, and is thereby guided toward the light receiving unit 41 so as to travel backward relative to the projection beam PB.

The light receiving unit 41 has a light receiving lens unit 42 and a light receiving detection unit 45. As shown in FIG. 1, the light receiving lens unit 42 has a structure in which at least one light receiving lens 43 is supported by a lens barrel 44. The translucent light receiving lens 43 has a lens shape corresponding to an optical action to be exerted, and is mainly made of base material, such as resin or glass. The light receiving lens 43 exerts an optical action so as to image the reflection beam RB transferred from the scanning mirror 32 onto the light receiving detection unit 45. The light receiving lens 43 is positioned in the light-shielding lens barrel 44, which is made of, for example, metal, resin, or the like. The light receiving lens unit 42 having such a configuration defines a light receiving optical axis RO for guiding the reflection beam RB transferred from the scanning unit 31 toward the light receiving detection unit 45 by being aligned with the light receiving detection unit 45. The light receiving lens unit 42 is aligned with the light receiving detection unit 45 such that the light receiving optical axis RO is shifted in the vertical direction from the projection optical axis PO of the projection lens unit 26.

As shown in FIG. 4, the light receiving detection unit 45 is constructed by mounting multiple light receiving pixels 46 in an array on a substrate. Each light receiving pixel 46 is arranged at least along the vertical direction. The light receiving detection unit 45 defines a light receiving surface 450 exhibiting a rectangular contour having longitudinal sides along the vertical direction and transverse sides along the horizontal direction on one surface of the substrate. The light receiving surface 450 is configured as an aggregate of incident surfaces defined in respective light receiving pixels 46. Each light receiving pixel 46 may include multiple single photon avalanche diodes (SPAD) as the multiple light receiving elements 460. Each light receiving pixel 46 receives the reflection beam RB incident on the light receiving surface 450. The reflection beam RB is transferred from the light receiving lens unit 42 as shown in FIG. 1.

As shown in FIG. 1 and FIG. 2, the light receiving detection unit 45 includes an output circuit 47. The output circuit 47 executes sampling process for each scanning line in every detection cycle corresponding to a control signal output from the control unit 51. The scanning line corresponds to the rotation angle of the scanning mirror 32, which is synchronized with a projection cycle of the projection beam PB by the projection light source unit 22. At this time, the output circuit 47 generates a detection signal by synthesizing response outputs from the light receiving elements 460 of each light receiving pixel 46 for each detection cycle. The detection signal thus generated is outputted from the output circuit 47 to the control unit 51 for each scanning line.

The control unit 51 is implemented by a control device including at least one dedicated computer mounted on a substrate. The dedicated computer implementing the control device as the control unit 51 may be a sensor ECU (Electronic Control Unit) specialized for controlling the optical sensor 10. In this case, the sensor ECU is accommodated in the housing unit 11 as shown in the example of FIG. 1. The dedicated computer implementing the control device as the control unit 51 may be a driving control ECU specialized for controlling driving of the mobile object 1. In this case, the driving control ECU is arranged outside the housing unit 11 in the mobile object 1 (not shown).

The dedicated computer implementing the control device as the control unit 51 has at least one memory 51a and one processor 51b, as shown in FIG. 1. The memory 51a is at least one type of non-transitory tangible storage medium such as, for example, a semiconductor memory, a magnetic medium, and an optical medium, which non-temporarily stores program and data readable by the computer. The processor 51b includes at least one type among, for example, a CPU (Central Processing Unit), a GPU (Graphics Processing Unit), a RISC (Reduced Instruction Set Computer)-CPU, a DFP (Data Flow Processor), and a GSP (Graph Streaming Processor), as a core.

The control unit 51 having such a configuration is connected to the projection light source unit 22, the scanning motor 35, and the light receiving detection unit 45. The control unit 51 controls the projection light source unit 22 so as to generate the projection beam PB for each projection cycle. At the same time, the control unit 51 controls the scanning motor 35 so as to control scanning and reflection by the scanning mirror 32 synchronized with the projection cycle of the projection light source unit 22. Furthermore, the control unit 51 processes the detection signal outputted from the output circuit 47 of the light receiving detection unit 45. The detection signal outputted from the output circuit 47 of the light receiving detection unit 45 is controlled corresponding to projection by the projection light source unit 22 and scanning and reflection by the scanning mirror 32. Thereby, the control unit 51 generates detection data that at least indicates the distance L to the detected target Xt existing in the detection area DA.

In order to specifically implement such control, the processor 51b executes multiple instructions included in a control program stored in the memory 51a. Thereby, the control unit 51 implements multiple functional blocks for controlling the optical sensor 10. The multiple functional blocks implemented by the control unit 51 in this way include an update block 100 and a detection block 120, as shown in FIG. 2.

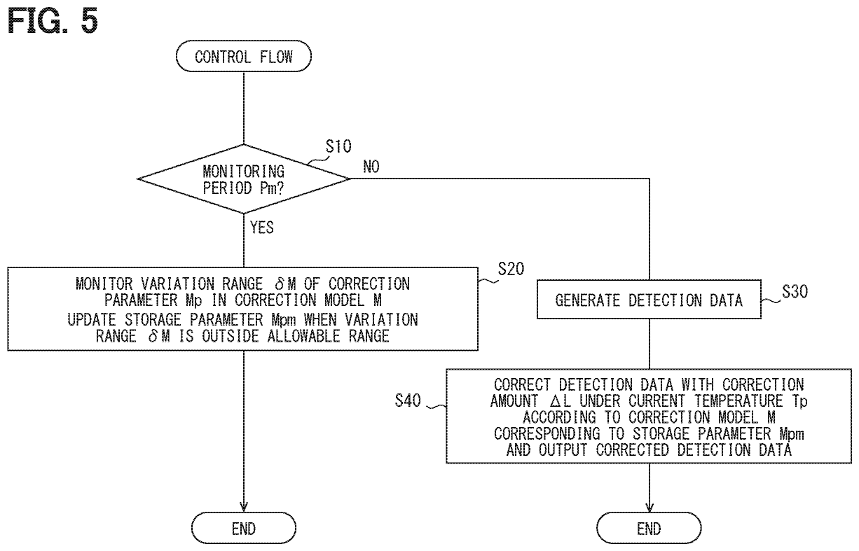

By cooperation of the update block 100 and the detection block 120, a control method by which the control unit 51 controls the optical sensor 10 is executed according to a control flow shown in FIG. 5. This control flow is repeatedly executed for each detection cycle while the mobile object 1 is in an activated state. Note that each “S” in the control flow means a step executed by one or more instructions included in the control program.

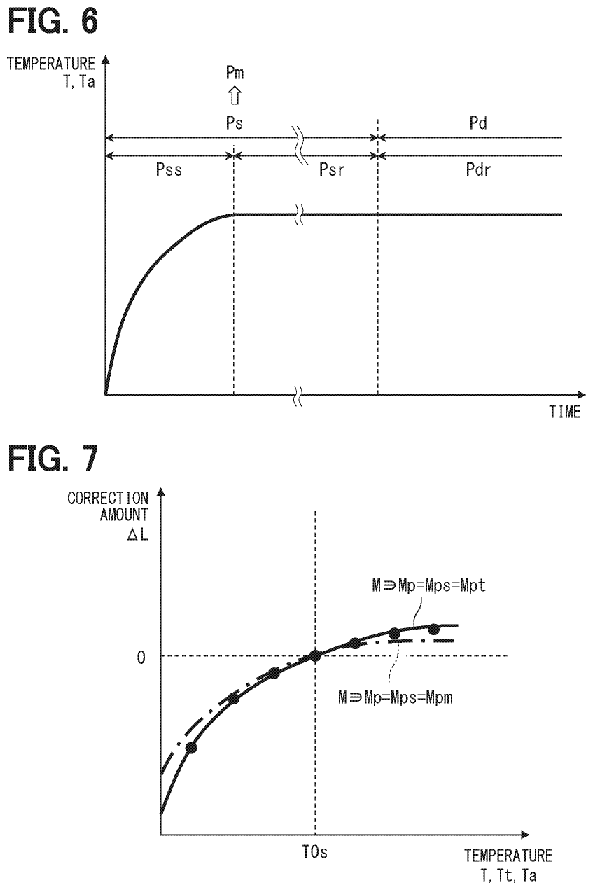

In S10 shown in FIG. 5, the update block 100 (see FIG. 2) determines whether or not the current detection cycle satisfies a condition of a monitoring period Pm. Here, the monitoring period Pm is a period for monitoring a variation range δM of a correction parameter Mp in a correction model M, which will be described later. The monitoring period Pm is set to a stop period Ps shown in FIG. 6, which is a period during which at least the mobile object 1 is in stopped state. The monitoring period Pm may be set to a further conditional stop period Ps, for example, a period during which the mobile object 1 is parked in a parking lot. The stop action of the mobile object 1, which serves as a trigger for setting such a stop period Ps, may be recognized based on a detection result of a traveling speed by, for example, a speed sensor or the like mounted on the mobile object 1. The stop action of the mobile object 1 may be recognized based on a detection result of a road surface by, for example, the optical sensor 10, another LiDAR, or a camera mounted on the mobile object 1. The stop action of the mobile object 1 may be recognized by fusion of these detection results of the traveling speed and the road surface. In FIG. 6, an example of a time transition related to an operation state of the optical sensor 10 is schematically illustrated with a temperature T° C. (particularly temperature Ta described later) serving as one state index of the optical sensor 10 as a vertical axis.

The monitoring period Pm may be set when a startup monitoring condition is satisfied in a startup period Pss during which the optical sensor 10 is starting up as shown in FIG. 6, within the stop period Ps of the mobile object 1. Here, the startup monitoring condition may be satisfied every time a set time period has been elapsed since the latest startup period Pss was set to the monitoring period Pm. The startup monitoring condition may be satisfied every time the number of appearances of the startup period Pss reaches a set number of times since the latest startup period Pss was set to the monitoring period Pm. Note that the startup of the optical sensor 10 may be a simultaneous startup of the mobile object 1 together with the optical sensor 10 according to a startup command made by a user. The startup of the optical sensor 10 may be an automatic startup of the optical sensor 10 in response to wake-up of the mobile object 1, which has been in a sleep state, according to a user command made by a user in nighttime.

The monitoring period Pm may be set when a steady monitoring condition is satisfied in a steady period Psr during which the operation of the optical sensor 10 is stabilized and the optical sensor 10 enters a steady state after the startup period Pss as shown in FIG. 6, within the stop period Ps of the mobile object 1. Here, the steady monitoring condition may be satisfied every time a set time period has been elapsed since the latest steady period Psr was set to the monitoring period Pm. The steady monitoring condition may be satisfied every time the number of appearances of the steady period Psr reaches a set number of times since the latest steady period Psr was set to the monitoring period Pm.

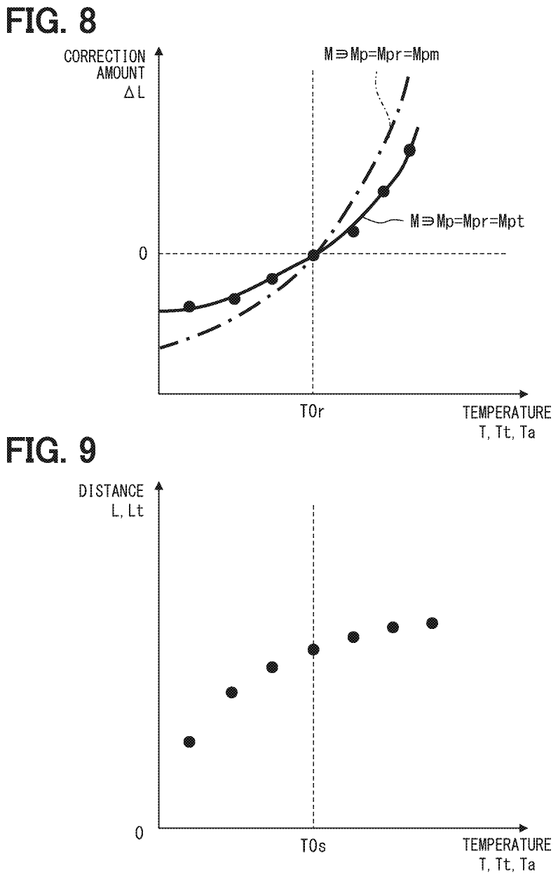

As shown in FIG. 5, when an affirmative determination is made in S10, S20 is executed. In S20, the update block 100 monitors a correction model M (see FIG. 7 and FIG. 8 to be described in detail later) for calculating a correction amount ΔL. The correction amount ΔL is an amount for correcting detection data of the distance L depending on the temperature T. At this time, in S20, the variation range δM of the correction parameter Mp in the correction model M is monitored. The correction parameter Mp defines a dependence level of the temperature T with respect to the correction amount ΔL of the distance L. Here, the correction amount ΔL is defined as a positive or negative detection deviation amount depending on the temperature T with reference to the detected distance L. As the temperature T, temperatures Ta, Tb, and Tc (see Equation 1 and Equation 5 described later) for each of specific sensor elements included in the optical sensor 10 are focused on.

Specifically, in S20, when the current detection cycle corresponds to the startup period Pss, which is set as the monitoring period Pm within the stop period Ps, as shown in FIG. 7, a startup parameter Mps is monitored as the correction parameter Mp using the correction model M corresponding to the startup period Pss. At this time, under a condition that the detection deviation amount of the distance L depends on each of the temperatures Ta, Tb, and Tc of the specific sensor elements included in the optical sensor 10, coefficient parameters As, Bs, and Cs representing dependence levels of these temperatures Ta, Tb, and Tc are defined in the startup parameter Mps according to Equation 1. Further, a constant parameter Ds common to the temperatures Ta, Tb, and Tc is defined in the startup parameter Mps according to Equation 1.

$$M : Δ L = G a ( As , Ta ) + Gb ( Bs , Tb ) + Gc ( Cs , Tc ) + Ds \qquad ( Equation 1 )$$

$$[ Mp = Mps ∋ As , Bs , Cs , Ds ]$$

$$[ T = Tt , Tp ∋ Ta , Tb , Tc ]$$

In Equation 1, each of the functions Ga, Gb, and Gc is defined as polynomials or monomials in which the order related to the corresponding temperatures Ta, Tb, and Tc is one or higher and no constant term exists. Therefore, in each term of the polynomial or the monomial constituting the function Ga, a coefficient corresponding to an exponent of the temperature Ta is defined as the parameter As. Thereby, particularly in the case of a polynomial, an individual parameter As is defined for each exponent of the temperature Ta in each term. For the parameters Bs and Cs, relationships with the corresponding functions Gb and Gc are defined similar to the relationship between the parameter As and the function Ga.

In this way, as each of the parameters As, Bs, Cs, and Ds set as the startup parameter Mps, an initial value at the time of product shipment of the optical sensor 10 or an update value described later in the startup period Pss is stored in the memory 51a. Therefore, stored values of such parameters As, Bs, Cs, and Ds are defined as storage parameters Mpm related to the startup parameters Mps as shown in FIG. 7.

Here, the sensor element corresponding to the temperature Ta is the projection light source unit 22. Therefore, the temperature Ta of the projection light source unit 22 is actually measured by a temperature sensor 29 (see FIG. 3) arranged on the same substrate as the light source elements 24. The sensor element corresponding to the temperature Tb is the light receiving detection unit 45. Since the temperature Tb of the light receiving detection unit 45 correlates with the temperature Ta of the projection light source unit 22, the temperature Tb of the light receiving detection unit 45 is estimated according to a function Fb shown in Equation 2. Furthermore, the sensor element corresponding to the temperature Tc is the control device serving as the control unit 51 or a mounting board of the control device. Since the temperature Tc of the control device or the mounting board thereof correlates with the temperature Ta of the projection light source unit 22, the temperature Tc is estimated according to a function Fc shown in Equation 3.

$$Tb = Fb ( Ta ) \qquad ( Equation 2 )$$

$$Tb = F b ( Ta ) \qquad ( Equation 3 )$$

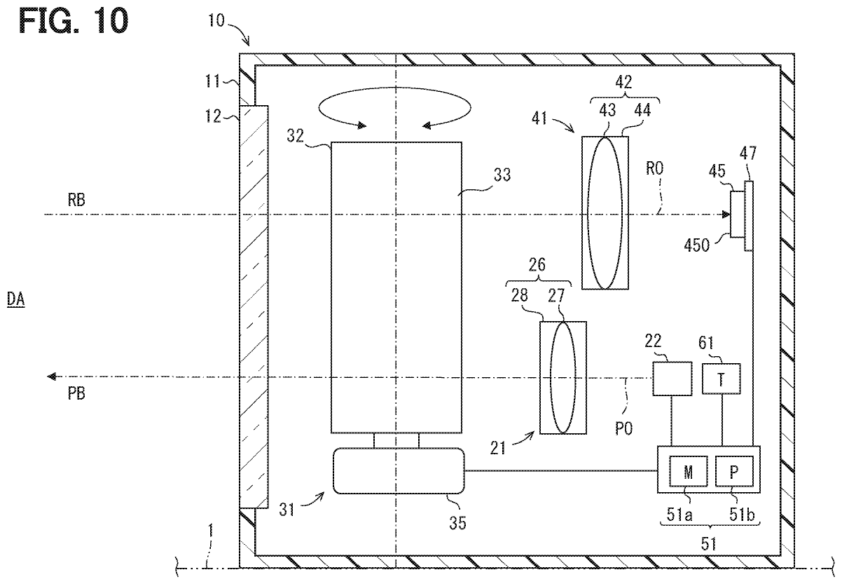

When the current detection cycle corresponds to the startup period Pss set as the monitoring period Pm, in S20, the update block 100 changes the temperatures Ta, Tb, and Tc for respective sensor elements as trial temperatures Tt shown in FIG. 9. At this time, change points of the temperatures Ta, Tb, and Tc as the trial temperatures Tt are set by multiple points so that one point of each of the temperatures Ta, Tb, and Tc corresponds to each other based on the correlation of Equation 2 and Equation 3. Therefore, by adjusting light emission power through controlling light emission from each light source element 24 of the projection light source unit 22, the update block 100 can directly sets multiple change points of the temperature Ta and indirectly set multiple change points of the temperatures Tb and Tc according to Equation 2 and Equation 3. Alternatively, as shown in a modification example of FIG. 10, by arranging a temperature adjustment unit 61 additionally connected to the control unit 51 to adjust an ambient temperature Ti in the housing unit 11, the update block 100 may indirectly set multiple change points of the temperature Ta correlating with the ambient temperature Ti according to a function Fa of Equation 4, and indirectly set multiple change points of the temperatures Tb and Tc according to Equation 2 and Equation 3. Here, the temperature adjustment unit 61 includes at least one type among, for example, a heater unit, a cooling unit, and the like.

$$Ta = Fa ( Ti ) \qquad ( Equation 4 )$$

When the current detection cycle corresponds to the startup period Pss set as the monitoring period Pm, in S20, the update block 100 acquires the distance L detected by the optical sensor 10 at change points corresponding to each of the temperatures Ta, Tb, and Tc as the trial temperatures Tt (hereinafter referred to as for each corresponding change point) as trial distances Lt as shown in FIG. 9. At this time, as the trial distance Lt for each corresponding change point of the temperature Ta, Tb, and Tc, a distance L to a stationary (stopped) target Xt such as a structure or a stopped vehicle may be detected by the optical sensor 10 of the stopped mobile object 1 by receiving the reflection beam RB from the target Xt. Here, the stationary state of the target Xt may be recognized based on a detection result of the target Xt by, for example, the optical sensor 10, another LiDAR, or a camera mounted on the mobile object 1.

In S20 corresponding to the startup period Pss, the update block 100 acquires the startup parameter Mps giving the correction model M as trial parameters Mpt by, for example, regression analysis so as to interpolate the detection deviation amount of the trial distance Lt acquired for each corresponding change point of the temperatures Ta, Tb, and Tc with respect to the trial distance Lt acquired at a specific reference corresponding change point among the temperatures Ta, Tb, and To as shown in FIG. 7. At this time, the parameters As, Bs, Cs, and Ds according to Equation 1 are set as the startup parameter Mps acquired as the trial parameters Mpt. In each of FIG. 7 and FIG. 9, an example of the correction model M with the startup parameter Mps and distance detection in the startup period Pss is illustrated with the temperature Ta corresponding to the temperatures Tb and Tc according to Equation 2 and Equation 3 as the horizontal axis of temperatures T and Tt. At the same time, in FIG. 7 and FIG. 9, each corresponding change point of the temperatures Ta, Tb, and Tc is indicated by a black solid circle. Among these temperatures, the temperature Ta at the reference corresponding change point serving as a reference for the detection deviation amount is indicated by a symbol TOs.

When the current detection cycle corresponds to the startup period Pss set as the monitoring period Pm, in S20, the update block 100 reads the parameters As, Bs, and Cs, which are the latest storage parameters Mpm related to the startup parameter Mps, from the memory 51a. Therefore, in S20 corresponding to the startup period Pss, the update block 100 focuses on a difference between (i) the trial parameter Mpt acquired in the current detection cycle related to the startup parameter Mps and (ii) the latest storage parameter Mpm read out related to the startup parameter Mps, as the variation range δM. Then, the update block 100 monitors the variation range δM for each of the coefficient parameters As, Bs, and Cs corresponding to each sensor element. At this time, in the function Ga of Equation 1, the variation range δM is monitored for each coefficient parameter As of each term having a different exponent of the temperature Ta in a polynomial, or solely for the coefficient parameter As corresponding to the exponent of the temperature Ta in a monomial. According to this, also in the functions Gb and Gc of Equation 1, the variation range δM is monitored for each of the coefficient parameters Bs and Cs of each term having a different exponent of the corresponding temperatures Tb and Tc in polynomials, or solely for the coefficient parameters Bs and Cs corresponding to the exponents of the corresponding temperatures Tb and Tc in monomials.

By such monitoring, in S20 of the startup period Pss, when the variation range δM corresponding to at least one sensor element among the variation ranges OM for each of the coefficient parameters As, Bs, and Cs increases to a value outside a preset allowable range, the storage parameter Mpm related to the startup parameter Mps is updated in the memory 51a as shown in FIG. 5. In the update related to the startup parameter Mps, learning of the storage parameter Mpm based on the trial parameter Mpt is performed for each of the coefficient parameters As, Bs, and Cs corresponding to each sensor element. At the same time, in the update of the startup parameter Mps, learning of the storage parameter Mpm based on the trial parameter Mpt is simultaneously performed for the constant parameter Ds.

In S20, when the current detection cycle corresponds to the steady period Psr set as the monitoring period Pm within the stop period Ps, as shown in FIG. 8, a steady parameter Mpr is monitored as the correction parameter Mp using the correction model M of the steady period Psr. At this time, under a condition that the detection deviation amount of the distance L depends on each of the temperatures Ta, Tb, and Tc for the same sensor elements as in the case of the startup period Pss, coefficient parameters Ar, Br, and Cr representing dependence levels of these temperatures Ta, Tb, and Tc are set as the steady parameter Mpr according to Equation 5. Further, a constant parameter Dr common to the temperatures Ta, Tb, and Tc is set as the steady parameter Mpr according to Equation 5. Here, since the optical sensor 10 is also in a steady state in a traveling period Pd of the mobile object 1, which is out of the stop period Ps after traveling start as shown in FIG. 6, the steady parameter Mpr is also set and monitored as the correction parameter Mp giving the correction model M of a steady period Pdr in the steady state.

$$M : Δ L = Ha ( Ar , Ta ) + Hb ( Br , Tb ) + Hc ( Cr , Tc ) + Dr \qquad ( Equation 5 )$$

$$[ Mp = Mpr ∋ Ar , Br , Cr , Dr ]$$

$$[ T = Tt , Tp ∋ Ta , Tb , Tc ]$$

In Equation 5, functions Ha, Hb, and Hc are defined as polynomials or monomials in which the order related to the corresponding temperatures Ta, Tb, and Tc is one or higher and no constant term exists, respectively. Therefore, in each term or single term of the polynomial constituting the function Ha, a coefficient corresponding to an exponent of the temperature Ta is defined as the parameter Ar. Thereby, particularly in the case of a polynomial, an individual parameter Ar is defined for each exponent of the temperature Ta in each term. For the parameters Br and Cr, relationships with the corresponding functions Hb and Hc are defined similar to the relationship between the parameter Ar and the function Ha.

In this way, as each of the parameters Ar, Br, Cr, and Dr set as the steady parameter Mpr, an initial value at the time of product shipment of the optical sensor 10 or an update value described later in the steady period Psr is stored in the memory 51a. Therefore, stored values of such parameters Ar, Br, Cr, and Dr are defined as storage parameters Mpm related to the steady parameter Mpr as shown in FIG. 8.

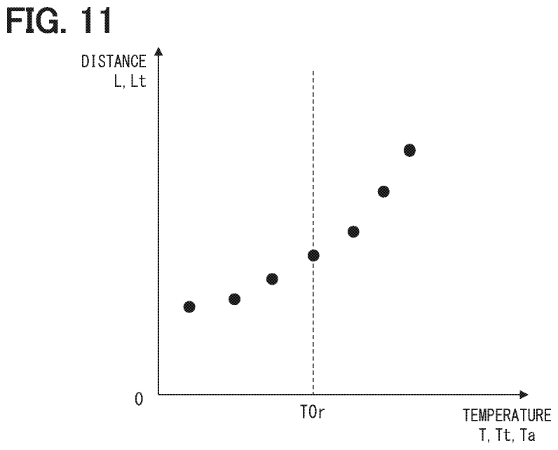

When the current detection cycle corresponds to the steady period Psr set as the monitoring period Pm, in S20, the update block 100 changes the temperatures Ta, Tb, and Tc for each sensor element as trial temperatures Tt shown in FIG. 11. At this time, a changing method of the temperatures Ta, Tb, and To as the trial temperatures Tt is similar to the case of where the startup period Pss is set as the monitoring period.

When the current detection cycle corresponds to the steady period Psr set as the monitoring period Pm, in S20, the update block 100 causes the optical sensor 10 to detect for each corresponding change point in the temperatures Ta, Tb, and Tc which are the trial temperatures Tt, and acquires the distance L as a trial distance Lt as shown in FIG. 11. At this time, as the trial distance Lt for each corresponding change point of the temperatures Ta, Tb, and Tc, the distance L to the stationary target Xt may be detected similar to the case of the startup period Pss. Here, the stationary state of the target Xt may be recognized based on a detection result of the target Xt by, for example, the optical sensor 10, another LiDAR, or a camera mounted on the mobile object 1.

In S20, the update block 100 corresponding to the steady period Psr acquires the steady parameter Mpr giving the correction model M as a trial parameter Mpt by, for example, regression analysis so as to interpolate the detection deviation amount of the trial distance Lt acquired for each corresponding change point in the temperatures Ta, Tb, and Tc with respect to the trial distance Lt acquired at a specific reference corresponding change point in the temperatures Ta, Tb, and Tc as shown in FIG. 8. At this time, the parameters Ar, Br, Cr, and Dr according to Equation 5 are set as the steady parameter Mpr acquired as the trial parameter Mpt. In FIG. 8 and FIG. 11, an example of the correction model M with the steady parameter Mpr and distance detection in the steady period Psr is illustrated with the temperature Ta corresponding to the temperatures Tb and Tc according to Equation 2 and Equation 3 as the horizontal axis of temperatures T and Tt. At the same time, in FIG. 8 and FIG. 11, each corresponding change point is indicated by a black solid circle in accordance with the startup period Pss of FIG. 7 and FIG. 9, while the temperature Ta different from that of the startup period Pss is indicated by a symbol T0r as the reference corresponding change point.

When the current detection cycle corresponds to the steady period Psr set as the monitoring period Pm, in S20, the update block 100 reads out the parameters Ar, Br, and Cr, which are the latest storage parameters Mpm related to the steady parameter Mpr, from the memory 51a. Therefore, in S20 of the steady period Psr, the update block 100 focuses on a difference between (i) the trial parameter Mpt acquired in the current detection cycle related to the steady parameter Mpr and (ii) the latest storage parameter Mpm read related to the steady parameter Mpr, as the variation range δM, and monitors the variation range δM for each of the coefficient parameters Ar, Br, and Cr corresponding to each sensor element. At this time, in the function Ha of Equation 5, the variation range δM is monitored for each coefficient parameter Ar of each term having a different exponent of the temperature Ta in a polynomial, or solely for the coefficient parameter Ar corresponding to the exponent of the temperature Ta in a monomial. According to this, also in the functions Hb and Hc of Equation 5, the variation range δM is monitored for each of the coefficient parameters Br and Cr of each term having a different exponent of the corresponding temperatures Tb and Tc in polynomials, or solely for the coefficient parameters Br and Cr corresponding to the exponents of the corresponding temperatures Tb and Tc in monomials.

By such monitoring, in S20 of the steady period Psr, when the variation range δM corresponding to at least one sensor element among the variation ranges OM for each of the coefficient parameters Ar, Br, and Cr increases to a value outside a preset allowable range, the storage parameter Mpm related to the steady parameter Mpr is updated in the memory 51a as shown in FIG. 5. In the update related to the steady parameter Mpr at this time, learning of the storage parameter Mpm based on the trial parameter Mpt is performed for each of the coefficient parameters Ar, Br, and Cr for each sensor element. At the same time, in the update related to the steady parameter Mpr, learning of the storage parameter Mpm based on the trial parameter Mpt is simultaneously performed for the constant parameter Dr.

As shown in FIG. 5, when an affirmative determination is made in S10, the current execution of the control flow ends upon completion of execution of S20. On the other hand, when a negative determination is made in S10, S30 and S40 are sequentially executed. First, in S30, the detection block 120 (see FIG. 2) controls the projection light source unit 22, the scanning motor 35, and the light receiving detection unit 45 to generate detection data in the current detection cycle.

Subsequently, in S40, the detection block 120 corrects the distance L of the detection data to be outputted by the correction amount ΔL, which matches to a current temperature Tp that is the temperature T in the current detection cycle, in accordance with the correction model M provided according to the latest storage parameter Mpm. As the current temperature Tp at this time, specifically, the temperatures Ta, Tb, and Tc for each sensor element are acquired. The temperature Ta may be actually measured by the temperature sensor 29, and further the temperatures Tb and Tc may be estimated according to Equation 2 and Equation 3.

In S40, when the current detection cycle corresponds to the startup period Pss which is not set as the monitoring period Pm within the stop period Ps, the detection block 120 reads the storage parameter Mpm related to the startup parameter Mps of Equation 1 from the memory 51a. Thereby, in the startup period Pss, the correction model M including the startup parameter Mps is selected as an input target of the current temperature Tp, so that the corrected detection data according to the correction model M is outputted.

In S40, when the current detection cycle corresponds to the steady period Psr which is not set as the monitoring period Pm within the stop period Ps, the detection block 120 reads the storage parameter Mpm related to the steady parameter Mpr of Equation 5 from the memory 51a. Thereby, in the steady period Psr, the correction model M including the steady parameter Mpr is selected as an input target of the current temperature Tp, so that the corrected detection data according to the correction model M is outputted. In the present embodiment, such output of the corrected detection data in accordance with the steady period Psr of the stop period Ps is also performed in S40 when the current detection cycle corresponds to the steady period Pdr (see FIG. 6) which substantially matches the traveling period Pd of the mobile object 1 that is outside of the stop period Ps.

Here, in any period, the output of the detection data in S40 may be storage of the detection data in the memory 51a. The output of the detection data in S40 may be provision of the detection data to, for example, a driving control ECU or the like. The output of the detection data in S40 may be transmission of the detection data to an external center through a communication unit of the mobile object 1.

Upon completion of execution of S40 described above, the current execution of the control flow ends. Therefore, by repeating the control flow other than in the monitoring period Pm, the detection data is corrected by the correction amount ΔL corresponding to the temperature T for each detection cycle of the distance L.

### (Effects)

The effects of the first embodiment described so far will be described below.

According to the first embodiment, in the correction model M for correcting the detection data of the distance L, which depends on the temperature T, the variation range δM of the correction parameter Mp defining the dependence level of the correction amount ΔL of the distance L on the temperature T is monitored. Therefore, when the variation range δM of the correction parameter Mp falls outside the allowable range set in advance, the storage parameter Mpm stored in the memory 51a as the correction parameter Mp is updated. Therefore, by correcting the detection data by the correction amount ΔL, which corresponds to the current temperature Tp at each detection cycle of the distance L, in accordance with the correction model M provided according to the latest storage parameter Mpm, it becomes possible to output the detection data in which the detection accuracy of the distance L is secured regardless of the elapse of time.

According to the first embodiment, the trial temperature Tt is changed in the monitoring period Pm for monitoring the variation range δM of the correction parameter Mp. The variation range δM is the difference between (i) the trial parameter Mpt as the correction parameter Mp giving the correction model M according to the trial distance Lt detected by the optical sensor 10 at each change point of the trial temperature Tt in the monitoring period Pm and (ii) the storage parameter Mpm. Such variation range OM is monitored. According to this, the trial parameter Mpt when the monitored variation range δM falls outside the allowable range can be accurately determined based on the trial distance Lt at multiple temperature points and used for updating the storage parameter Mpm. Therefore, by correcting the detection data in accordance with the correction model M provided according to the updated storage parameter Mpm, it becomes possible to output the detection data with improved detection accuracy of the distance L.

According to the first embodiment, the trial temperature Tt is changed in the monitoring period Pm set during the stopped state of the mobile object 1, whereby the trial distance Lt to the stationary target Xt is detected by the optical sensor 10 at each change point of the trial temperature Tt. According to this, by effectively utilizing the stationary target Xt for which the distance L is substantially invariant with respect to the stopped mobile object 1, the variation range δM occurring in the correction parameter Mp of the correction model M can be accurately monitored based on the trial distance Lt at multiple temperature points. Therefore, by correcting the detection data in accordance with the correction model M including the correction parameter Mp when the monitored variation range δM falls outside the allowable range as the latest storage parameter Mpm, it becomes possible to output the detection data ensuring high detection accuracy of the distance L.

According to the first embodiment, the temperatures Ta, Tb, and Tc for each sensor element included in the optical sensor 10 are respectively changed as the trial temperatures Tt in the monitoring period Pm. The variation range δM is the difference between (i) the trial parameter Mpt giving the correction model M according to the trial distance Lt detected by the optical sensor 10 at each change point of the trial temperature Tt in the monitoring period Pm and (ii) the storage parameter Mpm. Such variation range δM is monitored for each sensor element. Therefore, when the variation range δM corresponding to at least one sensor element falls outside the allowable range, learning of the storage parameter Mpm based on the trial parameter Mpt is performed for each sensor element, so that the detection data can be accurately corrected in accordance with the correction model M including the learned storage parameter Mpm. Therefore, it becomes possible to output the detection data ensuring high detection accuracy of the distance L.

According to the first embodiment, in the steady period Psr in which the steady state is established after the startup period Pss in which the optical sensor 10 is starting up, the variation range δM of the steady parameter Mpr as the correction parameter Mp giving the correction model M is monitored. Therefore, when the variation range δM monitored in the steady period Psr falls outside the allowable range, the storage parameter Mpm is updated related to the steady parameter Mpr. Therefore, by selecting the correction model M provided according to the latest storage parameter Mpm related to the steady parameter Mpr, it becomes possible to realize correction suitable for the steady periods Psr and Pdr in which the state of the optical sensor 10 is stabilized for the detection data, and improve the detection accuracy of the distance L.

According to the first embodiment, in the startup period Pss in which the optical sensor 10 is starting up, the variation range δM of the startup parameter Mps as the correction parameter Mp giving the correction model M is monitored. Therefore, when the variation range δM monitored in the startup period Pss falls outside the allowable range, the storage parameter Mpm is updated related to the startup parameter Mps. Therefore, in the startup period Pss, by selecting the correction model M corresponding to the latest storage parameter Mpm related to the startup parameter Mps, it becomes possible to realize correction specialized for the startup period Pss in which the state of the optical sensor 10 changes momentarily for the detection data, and improve the detection accuracy of the distance L.

### Second Embodiment

A second embodiment is a modification of the first embodiment.

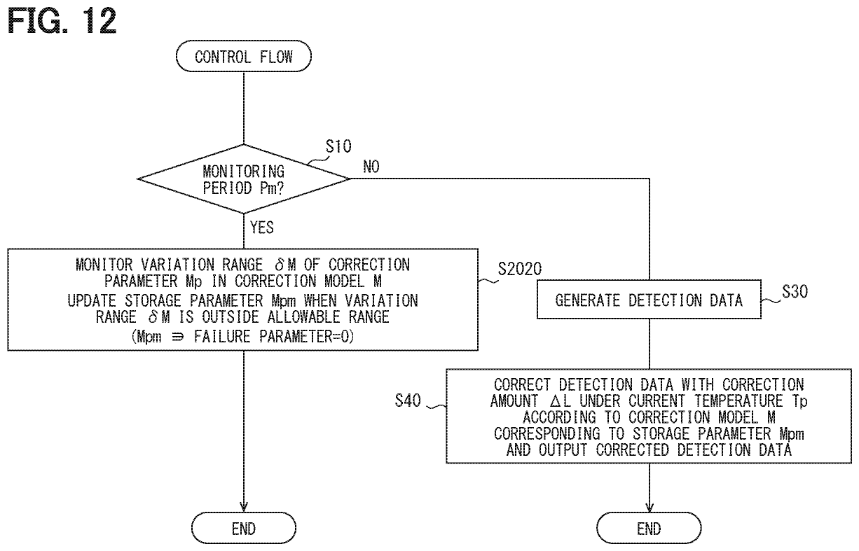

As shown in FIG. 12, in a control flow of the second embodiment, S2020 is executed instead of S20. Specifically, in S2020, the update block 100 corresponds to S20 up to the point where the storage parameter Mpm related to the startup parameter Mps as the correction parameter Mp is updated when the variation range δM corresponding to at least one sensor element among the variation ranges OM for each of the coefficient parameters As, Bs, and Cs falls outside the preset allowable range in the case where the current detection cycle corresponds to the startup period Pss set as the monitoring period Pm. In the update of the startup parameter Mps in S2020, a parameter corresponding to a sensor element for which the variation range δM is outside the allowable range among the coefficient parameters As, Bs, and Cs is forcibly set to a value of zero (0) as a failure parameter regardless of any exponent of the corresponding temperature among the temperatures Ta, Tb, and Tc.

In S2020, acquisition of the trial parameter Mpt by, for example, regression analysis or the like is re-executed for normal parameters other than the failure parameter updated to zero among the coefficient parameters As, Bs, and Cs, and the storage parameter Mpm is learned by the re-execution result. At this time, also for the constant parameter Ds, the storage parameter Mpm is learned based on the trial parameter Mpt whose acquisition was re-executed. Note that for the failure parameter forcibly set to the zero related to the startup parameter Mps, acquisition of the trial parameter Mpt, monitoring of the variation range δM, and update of the storage parameter Mpm are skipped while remaining at the zero until the optical sensor 10 is maintained.

Similarly, in S2020, the update block 100 corresponds to S20 up to the point where the storage parameter Mpm related to the steady parameter Mpr as the correction parameter Mp is updated when the variation range δM corresponding to at least one sensor element among the variation ranges OM for each of the coefficient parameters Ar, Br, and Cr falls outside the preset allowable range in the case where the current detection cycle corresponds to the steady period Psr set as the monitoring period Pm. In the update of the steady parameter Mpr in S2020, a parameter corresponding to a sensor element for which the variation range δM is outside the allowable range among the coefficient parameters Ar, Br, and Cr is forcibly set to a value of zero (0) as a failure parameter regardless of any exponent of the corresponding temperature among the temperatures Ta, Tb, and Tc.

Therefore, in S2020, acquisition of the trial parameter Mpt by, for example, regression analysis or the like is re-executed for normal parameters other than the failure parameter updated to zero among the coefficient parameters Ar, Br, and Cr, and the storage parameter Mpm is learned by the re-execution result. At this time, also for the constant parameter Dr, the storage parameter Mpm is learned based on the trial parameter Mpt whose acquisition was re-executed. Note that for the failure parameter forcibly set to zero related to the steady parameter Mpr, acquisition of the trial parameter Mpt, monitoring of the variation range δM, and update of the storage parameter Mpm are skipped while remaining at zero until the optical sensor 10 is maintained.

According to the second embodiment described above, the failure parameter which is the storage parameter Mpm of the sensor element for which the variation range δM falls outside the allowable range is updated to zero. Thereby, the correction model M can be updated so as to be defined by the storage parameter Mpm of the normal sensor element together with the failure parameter of zero. Therefore, by correcting the detection data in accordance with the updated correction model M, it becomes possible to output the detection data in which deterioration of the detection accuracy of the distance L can be suppressed.

### Third Embodiment

A third embodiment is a modification of the first embodiment.

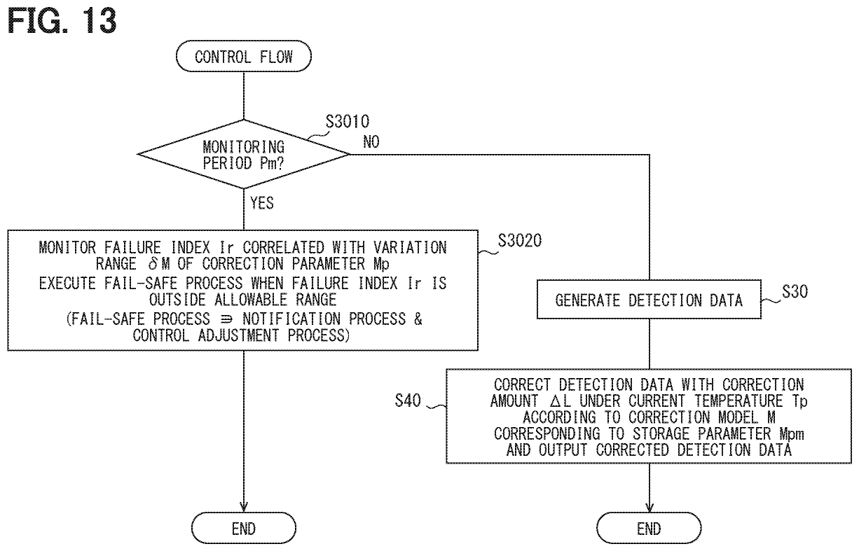

As shown in FIG. 13, in a control flow of the third embodiment, S3010 and S3020 are executed instead of S10 and S20. Specifically, in S3010, the update block 100 skips the success or failure determination of the startup monitoring condition in the startup period Pss, and sets the steady period Psr as the monitoring period Pm only when the steady monitoring condition is satisfied. In S3020 corresponding thereto, the update block 100 skips acquisition of the trial parameter Mpt, monitoring of the variation range δM, and update of the storage parameter Mpm related to the startup parameter Mps as the correction parameter M.

In S3020, when the current detection cycle corresponds to the steady period Psr set as the monitoring period Pm, the update block 100 corresponds to S20 up to the point of focusing on the variation range δM for each of the coefficient parameters Ar, Br, and Cr corresponding to each sensor element related to the steady parameter Mpr as the correction parameter M. However, in S3020, the update block 100 monitors a failure index Ir correlating with the variation range δM related to the steady parameter Mpr for each of the coefficient parameters Ar, Br, and Cr corresponding to each sensor element. That is, in the steady period Psr as the monitoring period Pm in the third embodiment, the failure index Ir correlating with the variation range δM of the steady parameter Mpr which is the correction parameter Mp is monitored for each sensor element.

At this time, in S3020, in the function Ha of Equation 5 described in the first embodiment, a failure probability correlating with the variation range δM is set by a function I_n of Equation 6 for each coefficient parameter Ar of each term having a different exponent n (n: index identifying an exponent) of the temperature Ta in a polynomial, or solely for the coefficient parameter Ar corresponding to the exponent n of the temperature Ta in a monomial. Here, the failure probability function I_n is defined to represent a state in which the probability of failure due to, for example, aging deterioration of the corresponding sensor element increases as the variation range δM of the coefficient parameter Ar increases.

$${I}_{r} = I\_N ( I\_n ) \qquad ( Equation 6 )$$

Therefore, in S3020, when the function Ha of Equation 5 is a polynomial, the failure index Ir of the sensor element commonly corresponding to the coefficient parameters Ar of respective exponents n is monitored according to an index function I_N (for example, a weighted average function or the like) of Equation 6 using calculation values by the failure probability function I_n for each coefficient parameter Ar having a different exponent n of the temperature Ta as multiple variables in the index function I_N. Alternatively, when the function Ha of Equation 5 is a monomial, the failure index Ir of the sensor element corresponding to the single coefficient parameter Ar is monitored according to the index function I_N using a calculation value by the failure probability function I_n for the single coefficient parameter Ar corresponding to the exponent n of the temperature Ta as one variable in the index function I_N (for example, a proportional function with a proportionality coefficient of 1 or the like) of Equation 6. In any case, the index function I_N giving the failure index Ir is defined so that the calculation value increases following an increase in the failure probability by the function I_n. In accordance with the above, also in the functions Hb and Hc of Equation 5 described in the first embodiment, the failure index Ir is monitored from the failure probability correlating with the variation range δM for each of the coefficient parameters Br and Cr of each term having a different exponent n of the corresponding temperatures Tb and Tc in polynomials, or solely for the coefficient parameters Br and Cr corresponding to the exponents n of the corresponding temperatures Tb and Tc in monomials.

By such monitoring, in S3020, when the failure index Ir corresponding to at least one sensor element among the failure indices Ir for each of the coefficient parameters Ar, Br, and Cr increases to a value outside a preset allowable range, the update block 100 performs fail-safe processing. Specifically, the fail-safe processing of S3020 includes notification processing and control adjustment processing. In the notification processing of S3020, data representing failure notification information for notifying the mobile object 1 of a mounting destination of a state of a sensor element for which the failure index Ir has fallen outside the allowable range in the optical sensor 10 as a failure state is outputted from the control unit 51.

Along with such notification processing, in the control adjustment processing of S3020, a control parameter for controlling the sensor element for which the failure index Ir has fallen outside the allowable range in the optical sensor 10 is adjusted to a recovery side for recovering the failure state of the sensor element outside the allowable range. At this time, when the failure index Ir corresponding to the coefficient parameter Ar having a different exponent n or being single falls outside the allowable range, for the projection light source unit 22 of the projection unit 21 determined to be a sensor element in a failure state, adjustment such as increasing or decreasing light emission power to the recovery side of the failure state may be performed as a control parameter of each light source element 24, for example.

At this time, when the failure index Ir corresponding to the coefficient parameter Br having a different exponent n or being single falls outside the allowable range, for the light receiving detection unit 45 of the light receiving unit 41 determined to be a sensor element in a failure state, adjustment such as increasing or decreasing light receiving sensitivity of the light receiving element 460 to the recovery side of the failure state may be performed as a control parameter of each light receiving pixel 46 by the output circuit 47, for example. When the failure index Ir corresponding to the coefficient parameter Br having a different exponent n or being single falls outside the allowable range, for the light receiving detection unit 45 of the light receiving unit 41 determined to be a sensor element in a failure state, under control in which a part of all light receiving pixels 46 is assigned as a light receiving area for each scanning line, adjustment such as increasing or decreasing sensitivity in the entire light receiving area to the recovery side of the failure state by increasing the number of the assigned pixels 46 (that is, expansion of the light receiving area for each scanning line) or deviation of the range of the assignment may be performed. Note that when the failure index Ir corresponding to the coefficient parameter Cr having a different exponent n or being single falls outside the allowable range, if the control unit 51 is determined to be a sensor element in a failure state, the control adjustment processing may be skipped and the notification processing may be performed alone.

### (Effects)

The effects of the third embodiment described so far will be described below.

According to the third embodiment, in the correction model M for correcting the detection data of the distance L depending on the temperature T, the failure index Ir correlating with the variation range δM of the correction parameter Mp defining the dependence level of the correction amount ΔL of the distance L on the temperature T is monitored. Therefore, the failure notification information notifying the failure state is outputted with the state of the optical sensor 10 in which the failure index Ir falls outside the allowable range as the failure state. In this way, in the optical sensor 10, since the failure state can be accurately notified by the failure notification information, conversely, under a normal state without the notification, the detection data is corrected according to the current temperature Tp at each detection of the distance L in accordance with the correction model M, whereby it becomes possible to output the detection data in which the detection accuracy of the distance L can be secured.

According to the third embodiment, with the state of the optical sensor 10 in which the failure index Ir falls outside the allowable range as the failure state, the control parameter for controlling the optical sensor 10 is adjusted to the recovery side of the failure state. In this way, in the optical sensor 10, since recovery of the failure state can be attempted by the adjustment of the control parameter, under the recovery, the detection data is corrected according to the current temperature Tp at each detection of the distance L in accordance with the correction model M, so it becomes possible to output the detection data in which the detection accuracy of the distance L can be secured.

According to the third embodiment, the trial temperature Tt is changed in the monitoring period Pm for monitoring the failure index Ir correlating with the variation range δM of the correction parameter Mp. Therefore, a difference between the trial parameter Mpt as the correction parameter Mp giving the correction model M according to the trial distance Lt detected by the optical sensor 10 at each change point of the trial temperature Tt in the monitoring period Pm, and the storage parameter Mpm is focused on as the variation range δM. According to this, when the failure index Ir monitored in correlation with the variation range δM falls outside the allowable range, necessity of output of the failure notification information can be appropriately determined based on variation of the trial parameter Mpt based on the trial distance Lt at multiple temperature points. Therefore, since the failure state can be accurately notified by the failure notification information, conversely, under a normal state, by correcting the detection data in accordance with the correction model M, it becomes possible to output the detection data in which the detection accuracy of the distance L can be secured.

According to the third embodiment, the trial temperature Tt is changed in the monitoring period Pm set during the stop of the mobile object 1, whereby the trial distance Lt to the stationary target Xt is detected by the optical sensor 10 at each change point of the trial temperature Tt. According to this, by effectively utilizing the stationary target Xt for which the distance L is substantially invariant with respect to the stopped mobile object 1, the variation range δM occurring in the correction parameter Mp of the correction model M can be accurately grasped based on the trial distance Lt at multiple temperature points and reflected in the failure index Ir. Therefore, when the monitored failure index Ir is within the allowable range, the detection data is corrected in accordance with the correction model M including the normal correction parameter Mp, so it becomes possible to output the detection data in which the detection accuracy of the distance L can be secured.

According to the third embodiment, the temperatures Ta, Tb, and Tc for each sensor element constituting the optical sensor 10 are respectively changed as the trial temperatures Tt in the monitoring period Pm. Therefore, in the monitoring period Pm, the failure index Ir correlated with the variation range δM, which is the difference between the trial parameter Mpt giving the correction model M according to the trial distance Lt detected at each change point of the trial temperature Tt by the optical sensor 10, and the storage parameter Mpm, is monitored for each sensor element. Therefore, when the failure index Ir corresponding to at least one sensor element falls outside the allowable range, necessity of output of the failure notification information can be accurately determined by focusing on variation of the trial parameter Mpt based on the trial distance Lt at multiple temperature points for each sensor element. Therefore, since the sensor element in the failure state can be accurately notified by the failure notification information, conversely, under a normal state, by correcting the detection data in accordance with the correction model M, it becomes possible to output the detection data in which the detection accuracy of the distance L can be secured.

### Fourth Embodiment

A fourth embodiment is a modification in which the third embodiment is combined with the second embodiment.

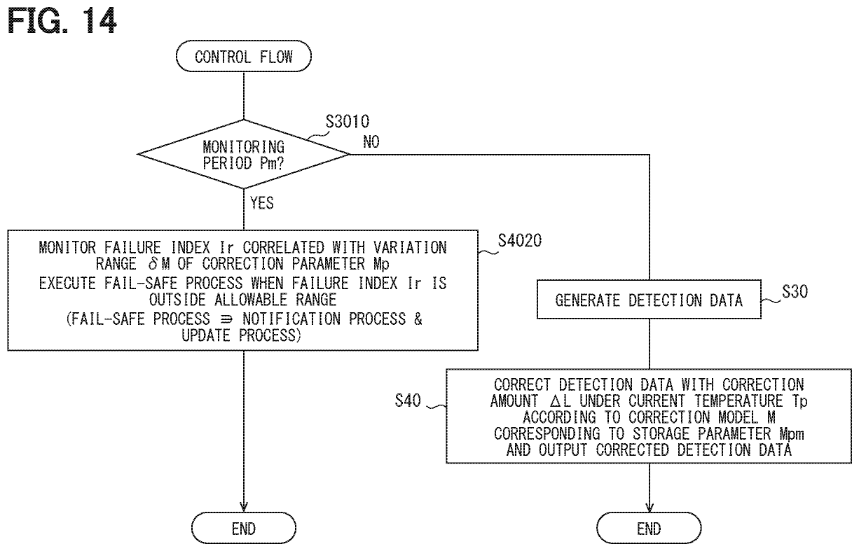

As shown in FIG. 14, in a control flow of the fourth embodiment, S4020 is executed instead of S3020. Specifically, in S4020, when the current detection cycle corresponds to the steady period Psr set as the monitoring period Pm, the update block 100 corresponds to S3020 up to the point of performing the notification processing as the fail-safe processing when the failure index Ir corresponding to at least one sensor element among the failure indices Ir for each of the coefficient parameters Ar, Br, and Cr falls outside the preset allowable range. However, in the fail-safe processing in S4020, update processing of the steady parameter Mpr in which a part of the second embodiment is modified is performed together with the notification processing. That is, in the update processing of S4020, a parameter corresponding to a sensor element for which the failure index Ir correlating with the variation range δM is outside the allowable range among the coefficient parameters Ar, Br, and Cr is forcibly set to a value of zero (0) as a failure parameter regardless of any exponent of the corresponding temperature among the temperatures Ta, Tb, and Tc.

Therefore, in the update processing of S4020, acquisition of the trial parameter Mpt by, for example, regression analysis or the like is re-executed for normal parameters other than the failure parameter updated to zero among the coefficient parameters Ar, Br, and Cr, and the storage parameter Mpm is learned by the re-execution result. At this time, also for the constant parameter Dr, the storage parameter Mpm is learned based on the trial parameter Mpt whose acquisition was re-executed. Note that for the failure parameter forcibly set to zero related to the steady parameter Mpr, acquisition of the trial parameter Mpt, monitoring of the failure index Ir, and update of the storage parameter Mpm are skipped while remaining at zero until the optical sensor 10 is maintained.

According to the fourth embodiment described above, the failure parameter which is the storage parameter Mpm of the sensor element for which the failure index Ir falls outside the allowable range is updated to zero. Thereby, the correction model M can be updated so as to be defined by the storage parameter Mpm of the normal sensor element together with the failure parameter of zero. Therefore, even after the sensor element in the failure state is once notified by the failure notification information, by correcting the detection data in accordance with the updated correction model M, it becomes possible to output the detection data in which deterioration of the detection accuracy of the distance L can be suppressed.

### OTHER EMBODIMENTS

Although multiple embodiments have been described above, the present disclosure is not limited to the above embodiments, and can be applied to various embodiments without departing from the spirit of the present disclosure.

In the modifications related to the first to fourth embodiments, the dedicated computer constituting the control device as the control unit 51 may include at least one of a digital circuit or an analog circuit, as the processor. Here, the digital circuit is at least one type among, for example, an ASIC (Application Specific Integrated Circuit), an FPGA (Field Programmable Gate Array), an SOC (System on a Chip), a PGA (Programmable Gate Array), and a CPLD (Complex Programmable Logic Device). Also, such a digital circuit may have a memory for storing a program.

In S10 of the control flow according to a modification related to the first and second embodiments, by omitting the correspondence determination of the startup period Pss set as the monitoring period Pm, the update by monitoring of the startup parameter Mps in S20 and S2020 may be omitted. In the first and second embodiments, in S40 of the control flow to which the modification omitting such startup period determination and update is applied, the correction itself by reading the storage parameter Mpm related to the startup parameter Mps may be omitted. In the first and second embodiments, in S40 of the control flow to which the modification omitting startup period determination and update is applied, correction by reading the storage parameter Mpm related to the steady parameter Mpr may be executed instead of the correction by reading the storage parameter Mpm related to the startup parameter Mps.

In S10 of the control flow according to a modification of the first and second embodiments, by omitting the correspondence determination of the steady period Psr set as the monitoring period Pm, the update by monitoring of the steady parameter Mpr in S20 and S2020 may be omitted. In the first and second embodiments, in S40 of the control flow to which the modification omitting such steady period determination and update is applied, the correction itself by reading the storage parameter Mpm related to the steady parameter Mpr may be omitted.

In S20 and S2020 of the control flow according to a modification of the first and second embodiments, one type or two types among the coefficient parameters As, Bs, and Cs may be unexpected as the startup parameter Mps in the startup period Pss set as the monitoring period Pm. In the first and second embodiments, for S20 and S2020 of the control flow to which such a modification with the unexpected startup parameter Mps is applied, the storage parameter Mpm may be updated related to at least one type set as the startup parameter Mps among the coefficient parameters As, Bs, and Cs according to the variation range δM which is a difference from the trial parameter Mpt. Furthermore, in S40 of the control flow to which the modification with the unexpected startup parameter Mps is applied, correction by reading the storage parameter Mpm related to the startup parameter Mps may be executed by acquiring at least one type among the temperatures Ta, Tb, and Tc as the current temperature Tp corresponding to at least one type set as the startup parameter Mps among the coefficient parameters As, Bs, and Cs.

In S20, S2020, S3020, and S4020 of a control flow according to a modification of the first to fourth embodiments, one type or two types among the coefficient parameters Ar, Br, and Cr may be unexpected as the steady parameter Mpr in the steady period Psr set as the monitoring period Pm. In the first to fourth embodiments, for S20, S2020, S3020, and S4020 of the control flow to which such a modification with the unexpected steady parameter Mpr is applied, the storage parameter Mpm may be updated related to at least one type set as the steady parameter Mpr among the coefficient parameters Ar, Br, and Cr according to the variation range δM which is a difference from the trial parameter Mpt. Furthermore, in S40 of the control flow to which the modification with the unexpected steady parameter Mpr is applied, correction by reading the storage parameter Mpm related to the steady parameter Mpr may be executed by acquiring at least one type among the temperatures Ta, Tb, and Tc as the current temperature Tp corresponding to at least one type set as the steady parameter Mpr among the coefficient parameters Ar, Br, and Cr.

In S20 and S2020 of a control flow according to a modification of the first and second embodiments, instead of the distance L to the stationary target Xt, a distance L to a specific reflector in the housing unit 11 may be detected as the trial distance Lt in the startup period Pss set as the monitoring period Pm. In S20, S2020, S3020, and S4020 of the control flow according to a modification of the first to fourth embodiments, instead of the distance L to the stationary target Xt, the distance L to the specific reflector in the housing unit 11 may be detected as the trial distance Lt in the steady period Psr set as the monitoring period Pm.

In a modification of the first to fourth embodiments, the mobile object 1 to which the control device executing the control method and control program described above as the control unit 51, and the optical sensor 10 provided therewith are applied may be, for example, an autonomous mobile robot capable of baggage transportation, information collection, or the like by autonomous traveling or remote traveling. In a modification of the first to fourth embodiments, the application target of the control device executing the control method and control program described above as the control unit 51, and the optical sensor 10 provided therewith may be, for example, infrastructure equipment such as a smart pole other than the mobile object 1.

In the first and second embodiments, in S20 and S2020 of the control flow controlling the optical sensor 10 applied to the infrastructure equipment as described above, instead of the distance L to the stationary target Xt, a distance L to a specific location on the ground may be detected as the trial distance Lt in the startup period Pss set as the monitoring period Pm. In the first to fourth embodiments, in S20, S2020, S3020, and S4020 of the control flow controlling the optical sensor 10 applied to the infrastructure equipment, instead of the distance L to the stationary target Xt, the distance L to the specific location on the ground may be detected as the trial distance Lt in the steady period Psr set as the monitoring period Pm.

In a modification of the third and fourth embodiments, the variation range OM itself may be monitored as the failure index Ir correlated with the variation range OM focused on in S3020 and S4020. In a modification of the fourth embodiment, in the update processing when the failure index Ir falls outside the allowable range in S4020, update of the storage parameter Mpm may be performed in accordance with the first embodiment. In a modification of the third and fourth embodiments, the notification processing in S3020 and S4020 may be skipped. In a modification of the third embodiment, the control adjustment processing in S3020 may be skipped. In a modification of the third and fourth embodiments, control according to the above description may be executed in the startup period Pss in addition to or instead of the steady period Psr. In addition to the described forms so far, in the first to fourth embodiments and each modification described above, the control device as the control unit 51 may be implemented by a semiconductor device (for example, a semiconductor chip or the like).

What is claimed is:

1. A control device comprising at least one of (i) a circuit and (ii) a processor with a memory storing computer program code executable by the processor, wherein the at least one of the circuit and the processor is configured to:
control an optical sensor, the optical sensor being configured to receive a reflection beam, which is generated when a projection beam projected toward a detection area is reflected by a target, and output detection data indicating a distance to the target;
update a storage parameter, which is stored in a storage medium as a correction parameter, in response to a variation range of the correction parameter falling outside an allowable range by monitoring the variation range of the correction parameter, the correction parameter defining a dependence level of a correction amount for the distance on a temperature in a correction model for correcting the detection data of the distance corresponding to the temperature; and
correct the detection data with the correction amount corresponding to the temperature at which each detection of the distance is performed in accordance with the correction model provided according to a latest storage parameter.

2. The control device according to claim 1, wherein the at least one of the circuit and the processor is further configured to:
in a case where a startup parameter is monitored as the correction parameter in the correction model of a startup period in which the optical sensor is starting up, update the storage parameter related to the startup parameter in response to the variation range of the startup parameter falling outside an allowable range;
in a case where a steady parameter is monitored as the correction parameter in the correction model of a steady period in which the optical sensor enters a steady operation state after the startup period, update the storage parameter related to the steady parameter in response to the variation range of the steady parameter falling outside an allowable range;
select the correction model provided according to the latest storage parameter related to the startup parameter and correct the detection data detected in the startup period; and
select the correction model provided according to the latest storage parameter related to the steady parameter and correct the detection data detected in the steady period.

3. The control device according to claim 1, wherein the at least one of the circuit and the processor is further configured to:
change a trial temperature which is the temperature in a monitoring period for monitoring the variation range;
monitor the variation range defined as a difference between (i) a trial parameter, which is the correction parameter giving the correction model according to the distance detected by the optical sensor at each change point of the trial temperature in the monitoring period and (ii) the storage parameter; and
update the storage parameter to the trial parameter in response to the variation range falling outside the allowable range.

4. The control device according to claim 3, wherein
the optical sensor is configured to be mountable on a mobile object, and
the at least one of the circuit and the processor is further configured to:
change the trial temperature in the monitoring period set in a stopped state of the mobile object; and
cause the optical sensor to detect the distance to the target, which is in a stationary state, at each change point of the trial temperature in the monitoring period set in the stopped state of the mobile object.

5. The control device according to claim 3, wherein the at least one of the circuit and the processor is further configured to:
change a temperature of each sensor element included in the optical sensor as the trial temperature in the monitoring period;
monitor the variation range for each sensor element, the variation range being defined as a difference between (i) the trial parameter, which is the correction parameter giving the correction model according to the distance detected by the optical sensor at each change point of the trial temperature in the monitoring period, and (ii) the storage parameter; and
perform learning of the storage parameter based on the trial parameter for each sensor element in response to the variation range corresponding to at least one sensor element falling outside the allowable range.

6. The control device according to claim 5, wherein the at least one of the circuit and the processor is further configured to
update the storage parameter of the at least one sensor element, in which the variation range falls outside the allowable range, to be zero.

7. A control device comprising at least one of (i) a circuit and (ii) a processor with a memory storing computer program code executable by the processor, wherein the at least one of the circuit and the processor is configured to:
control an optical sensor, the optical sensor being configured to receive a reflection beam, which is generated when a projection beam projected toward a detection area is reflected by a target, and output detection data indicating a distance to the target;
monitor a failure index correlating with a variation range of a correction parameter, the correction parameter defining a dependence level of a correction amount for the distance on a temperature in a correction model for correcting the detection data of the distance corresponding to the temperature; and
output failure notification information notifying a failure state of the optical sensor in which the failure index falls outside an allowable range.

8. The control device according to claim 7, wherein the at least one of the circuit and the processor is further configured to:
change a trial temperature which is the temperature in a monitoring period for monitoring the failure index; and
monitor the failure index correlated with the variation range, the variation range being defined as a difference between (i) a trial parameter, which is the correction parameter giving the correction model according to the distance detected by the optical sensor at each change point of the trial temperature in the monitoring period, and (ii) a storage parameter stored in a storage medium as the correction parameter.

9. The control device according to claim 8, wherein the at least one of the circuit and the processor is further configured to:
change a temperature of each sensor element included in the optical sensor as the trial temperature in the monitoring period;
monitor the failure index for each sensor element, the failure index being correlated with the variation range, and the variation range being defined as a difference between (i) the trial parameter, which is the correction parameter giving the correction model according to the distance detected by the optical sensor at each change point of the trial temperature in the monitoring period, and (ii) the storage parameter; and
output the failure notification information notifying the failure state of at least one sensor element in which the failure index falls outside the allowable range.

10. The control device according to claim 9, wherein the at least one of the circuit and the processor is further configured to
update the storage parameter of the at least one sensor element, in which the failure index falls outside the allowable range, to be zero.

11. The control device according to claim 7, wherein the at least one of the circuit and the processor is further configured to
adjust a control parameter for controlling the optical sensor to recover from the failure state of the optical sensor in which the failure index falls outside the allowable range.

12. A control device comprising at least one of (i) a circuit and (ii) a processor with a memory storing computer program code executable by the processor, wherein the at least one of the circuit and the processor is configured to:
control an optical sensor, the optical sensor being configured to receive a reflection beam, which is generated when a projection beam projected toward a detection area is reflected by a target, and output detection data indicating a distance to the target;
monitor a failure index correlating with a variation range of a correction parameter, the correction parameter defining a dependence level of a correction amount for the distance on a temperature in a correction model for correcting the detection data of the distance corresponding to the temperature; and
adjust a control parameter for controlling the optical sensor to recover from a failure state of the optical sensor in which the failure index falls outside an allowable range.

13. The control device according to claim 12, wherein the at least one of the circuit and the processor is further configured to:
change a trial temperature which is the temperature in a monitoring period for monitoring the failure index; and
monitor the failure index correlating with the variation range, the variation range being defined as a difference between (i) a trial parameter, which is the correction parameter giving the correction model according to the distance detected by the optical sensor at each change point of the trial temperature in the monitoring period, and (ii) a storage parameter stored in a storage medium as the correction parameter.

14. The control device according to claim 13, wherein the at least one of the circuit and the processor is further configured to:
change a temperature of each sensor element included in the optical sensor as the trial temperature in the monitoring period;
monitor the failure index for each sensor element, the failure index being correlated with the variation range, and the variation range being defined as a difference between (i) the trial parameter, which is the correction parameter giving the correction model according to the distance detected by the optical sensor at each change point of the trial temperature in the monitoring period, and (ii) the storage parameter, and
adjust the control parameter for controlling at least one sensor element in which the failure index falls outside the allowable range to recover from the failure state.

15. The control device according to claim 14, wherein the at least one of the circuit and the processor is further configured to,
when the at least one sensor element in which the failure index falls outside the allowable range is a projection unit that projects the projection beam, adjust the control parameter for controlling the projection unit to recover from the failure state.

16. The control device according to claim 14, wherein the at least one of the circuit and the processor is further configured to,
when the at least one sensor element in which the failure index falls outside the allowable range is a light receiving unit that receives the reflection beam, adjust the control parameter for controlling the light receiving unit to recover from the failure state.

17. The control device according to claim 8, wherein
the optical sensor is configured to be mountable on a mobile object, and
the at least one of the circuit and the processor is further configured to:
change the trial temperature in the monitoring period set in a stopped state of the mobile object; and
cause the optical sensor to detect the distance to the target, which is in a stationary state, at each change point of the trial temperature in the monitoring period set in the stopped state of the mobile object.

18. An optical sensor comprising:
a control unit including the control device according to claim 1 and configured to generate the detection data, the control unit outputting the detection data indicating a distance to a target, the detection data being generated by receiving the reflection beam from the target when a projection beam is projected toward a detection area and reflected by the target;
a projection unit configured to project the projection beam in accordance with control by the control unit; and
a light receiving unit configured to receive the reflection beam in accordance with control by the control unit.

19. A control method executed by a processor for controlling an optical sensor, the optical sensor being configured to receive a reflection beam, which is generated when a projection beam projected toward a detection area is reflected by a target, and output detection data indicating a distance to the target, the control method comprising:
updating a storage parameter, which is stored in a storage medium as a correction parameter, in response to a variation range of the correction parameter falling outside an allowable range by monitoring the variation range of the correction parameter, the correction parameter defining a dependence level of a correction amount for the distance on a temperature in a correction model for correcting the detection data of the distance corresponding to the temperature; and
correcting the detection data with the correction amount corresponding to the temperature at which each detection of the distance is performed in accordance with the correction model provided according to a latest storage parameter.

20. A control method executed by a processor for controlling an optical sensor, the optical sensor being configured to receive a reflection beam, which is generated when a projection beam projected toward a detection area is reflected by a target, and output detection data indicating a distance to the target, the control method comprising:
monitoring a failure index correlating with a variation range of a correction parameter, the correction parameter defining a dependence level of a correction amount for the distance on a temperature in a correction model for correcting the detection data of the distance corresponding to the temperature; and
outputting failure notification information notifying a failure state of the optical sensor in which the failure index falls outside an allowable range.

21. A control method executed by a processor for controlling an optical sensor, the optical sensor being configured to receive a reflection beam, which is generated when a projection beam projected toward a detection area is reflected by a target, and output detection data indicating a distance to the target, the control method comprising:
monitoring a failure index correlating with a variation range of a correction parameter, the correction parameter defining a dependence level of a correction amount for the distance on a temperature in a correction model for correcting the detection data of the distance corresponding to the temperature; and
adjusting a control parameter for controlling the optical sensor to recover from a failure state of the optical sensor in which the failure index falls outside an allowable range.

22. A non-transitory storage medium storing a control program for controlling an optical sensor, the optical sensor being configured to receive a reflection beam, which is generated when a projection beam projected toward a detection area is reflected by a target, and output detection data indicating a distance to the target, the control program comprising instructions for causing a processor of the optical sensor to execute:
updating a storage parameter, which is stored in a storage medium as a correction parameter, in response to a variation range of the correction parameter falling outside an allowable range by monitoring the variation range of the correction parameter, the correction parameter defining a dependence level of a correction amount for the distance on a temperature in a correction model for correcting the detection data of the distance corresponding to the temperature; and
correcting the detection data with the correction amount corresponding to the temperature at which each detection of the distance is performed in accordance with the correction model provided according to a latest storage parameter.

23. A non-transitory storage medium storing a control program for controlling an optical sensor, the optical sensor being configured to receive a reflection beam, which is generated when a projection beam projected toward a detection area is reflected by a target, and output detection data indicating a distance to the target, the control program comprising instructions for causing a processor of the optical sensor to execute:
monitoring a failure index correlating with a variation range of a correction parameter, the correction parameter defining a dependence level of a correction amount for the distance on a temperature in a correction model for correcting the detection data of the distance corresponding to the temperature; and
outputting failure notification information notifying a failure state of the optical sensor in which the failure index falls outside an allowable range.

24. A non-transitory storage medium storing a control program for controlling an optical sensor, the optical sensor being configured to receive a reflection beam, which is generated when a projection beam projected toward a detection area is reflected by a target, and output detection data indicating a distance to the target, the control program comprising instructions for causing a processor of the optical sensor to execute:
monitoring a failure index correlating with a variation range of a correction parameter, the correction parameter defining a dependence level of a correction amount for the distance on a temperature in a correction model for correcting the detection data of the distance corresponding to the temperature; and
adjusting a control parameter for controlling the optical sensor to recover from a failure state of the optical sensor in which the failure index falls outside an allowable range.
